(19) United States
(12) Patent Application Publication
(10) Pub. No.: US 2010/0229953 A1
(43) Pub. Date: Sep. 16, 2010

(54) METHOD AND APPARATUS FOR CLEANING HEAT TRANSFER STRUCTURES

(75) Inventor: Smith Stuart, Kinclaven (GB)

Correspondence Address: Woodcock Washburn LLP, Cira Centre, 12th Floor, 2929 Arch Street, Philadelphia, PA, 19104-2891, US

(73) Assignee: EPSCO LIMITED, PERTH (GB)

(21) Appl. No.: 12/441,711

(22) PCT Filed: Jun. 10, 2008
(86) PCT No.: PCT/GB2008/050429

§ 371 Date: Mar. 23, 2010

(30) Foreign Application Priority Data
Nov. 21, 2007 (GB) 0722765.5

(51) Int. Cl. F17D 3/00

(52) U.S. Cl. 137/1; 137/565.01

(57) ABSTRACT

The invention relates to an apparatus and method for the cleaning and/or disinfection of evaporative and/or convective cooling structures. The apparatus comprises means for drawing off predetermined volumes of one or more chemicals (optionally diluted with water) and pumping them into a corresponding number of dilution manifolds. Fluid-flow control means such as flow meters, non-return valves and control valves are employed to ensure that correct predetermined ratios/volumes of each fluid are drawn into the respective dilution manifolds, and to prevent undesired backflow of chemicals. The diluted or undiluted chemical agents then flow into a mixing manifold where they are mixed with other diluted or undiluted chemicals from one or more other dilution manifolds. The mixed chemicals are then delivered by means of an air gun or spray nozzle to clean packing material or other cooling structure components in situ within a cooling tower. Advantageously, any exothermic reactions are prevented until at least in or after the mixing manifold to increase safety.

The present invention relates to the cleaning of heat transfer structures and particularly, but not exclusively, to a method and apparatus for the cleaning and/or disinfection of evaporative cooling structures.

Cooling structures in the form of towers, which may operate on the basis of evaporative and/or convective cooling, are employed to cool a working medium (usually water) towards ambient temperature. Examples of cooling towers to which the present invention relates include inter alia refineries, chemical plants, power plants, food or drinks processing plants, semi-conductor plants etc. The cooling towers may range in size from relatively small rooftop structures to large parabolic structures having diameters and/or heights in excess of 100 m.

An inherent component in most evaporative cooling towers is a volume layer of packing material having a high surface area designed to enhance heat transfer efficiency. The packing material is usually a light weight plastics material and is known in the art as “fill”. By directing a heated working medium through the fill material (usually from above by the influence of gravity), its progress is interrupted by the material's complex fluted or corrugated surfaces and thus the volume of the working medium is sub-divided to present an increased wetted contact surface to the ambient air. The interruption of the working medium by labyrinthine surfaces in the fill material also acts to increase the available heat transfer time with the ambient air which typically moves in a direction opposite to that of the working medium.

A recognised problem with such cooling structures is that the fill material, and the other component parts of a cooling structure (e.g. drift eliminators, air deflectors, concrete or timber supports, fan cowlings, sump structures etc.) are susceptible to a gradual build up of surface deposits (also known as “fouling”) over time. Progressive fouling of fill material results in a corresponding gradual reduction in heat transfer efficiency. In particular, the water used in cooling systems is often of poor quality and this combined with the inherent elevated temperatures promotes the formation of surface deposits (including amongst others iron, manganese and calcium carbonate).

A related problem is the formation of bacteriological growths on the fluted or corrugated surfaces of the fill material and on the other component parts of a cooling structure. Not only do such deposits and growths act to reduce the overall surface area of the fill material, they also add significant additional weight which can result in a collapse of the fill material into the underlying collection sump. Furthermore, such deposits and growths can cause an undesired increase in the amount of drift and plume emitted from the cooling tower and increases the risk of bacteria and pathogens being discharged to the atmosphere. Minimising such discharges is now a legislative requirement in many countries, see for example IPPC Directive 96/61/EC. Bacteriological growth in particular may necessitate high dosages of biocide chemicals such as Cl₂ which are used to control bacteriological activity. It is important to completely remove all fouling to negate the risk of bacteria and pathogens being discharged to the atmosphere and to reduce the amount of chemical water treatment (biocide) being discharged to the atmosphere.

Several attempts have been made to overcome the aforementioned problems. To date, the most effective solution has been to remove the fouled fill material from the cooling tower for subsequent cleaning or replacement. However, these are both time consuming and expensive options. Not only is there a requirement for the cooling tower to be taken out of commission, but any replacement of fill material and disposal of spent fill material is costly. In view of the fragile nature of the fill material, it is also susceptible to damage through mishandling. If damaged within the cooling tower, pieces of plastics material can enter the cooling system and cause blockages in condensers etc.

As an alternative, attempts have been made to mechanically remove fouling in-situ by directing high pressure water jets at the fill material, either from above or below. However, this has proved to be relatively ineffective for a number of reasons. Firstly, fill material is normally arranged in blocks of at least two layers (and sometimes up to five layers), each block having a typical depth of 300 mm. Moreover, the axes of the flutes and/or corrugations within the fill material usually extend obliquely relative to the upper or lower surfaces of the blocks. Accordingly, the velocity (and hence energy) of water jets is quickly reduced upon contact with the fill material with the result that typically only the first 100 mm of depth of the material is cleaned to a satisfactory extent. In addition, there is an upper threshold limit to the energy of the water jets which can be employed for any given fill material if breakage of the light weight plastics from which it is formed is to be avoided. Similarly, if high pressure water is directed at drift eliminators it can cause damage to the lightweight plastics material. Likewise, if high pressure water is directed at timber support structures, the woodwork may become damaged through the removal of “wet rot” protective treatments which will promote premature rotting of the timber.

A further alternative cleaning option involves adding large volumes of chemicals to the whole cooling system. Whilst this may succeed in cleaning the pack, the high concentration of chemicals required to do so in a heavily fouled system can result in damage to other component parts of the cooling system, i.e. pumps, pipe-work, condensers etc. Moreover, within larger structures such as power plants, the volume throughput of cooling water is so great that it would usually be prohibitively expensive add sufficient volumes of chemicals to provide a satisfactory cleaning effect.

According to a first aspect of the present invention, there is provided apparatus for cleaning fill material in evaporative heat transfer structures, the apparatus comprising:
(i) two or more cleaning fluid input conduits;
(ii) fluid pumping means for selectively pumping fluids through each input conduit;
(iii) fluid-flow control means for selectively controlling the fluid flow through each input conduit;
(iv) a mixing manifold in fluid communication with each cleaning fluid input conduit; and
(v) an output conduit for delivering mixed cleaning fluid from the mixing manifold to a structure to be cleaned;
   wherein each fluid-flow control means comprises a non-return valve provided on the cleaning fluid input conduit for precluding inadvertent mixing of cleaning fluids upstream of the mixing manifold.

According to a second aspect of the present invention, there is provided a method for cleaning fill material in evaporative heat transfer structures, the method comprising the steps of:
(i) providing two or more sources of cleaning fluids;
(ii) selectively conveying cleaning fluid from one or more of their sources into a mixing manifold;
(iii) providing a non-return valve between each cleaning fluid source and the mixing manifold for precluding back flow and inadvertent mixing of cleaning fluids upstream of the mixing manifold; and
(iv) providing a delivery means to deliver the mixed cleaning fluid from the mixing manifold to a structure to be cleaned.

Embodiments of the present invention will now be described, by way of example only, with reference to the following drawings, in which:

FIG. 1 is a schematic cross-sectional view of a parabolic cooling tower showing a layer of fill material;

FIG. 2 is a schematic perspective view of an example of a block of fill material (without fouling);

FIG. 3a is a schematic sectional view along the axis A-A of one of the flutes of the block of FIG. 2 in dilution showing fouling on its internal surfaces;

FIG. 3b is a view corresponding to that of FIG. 3a after removal of the fouling;

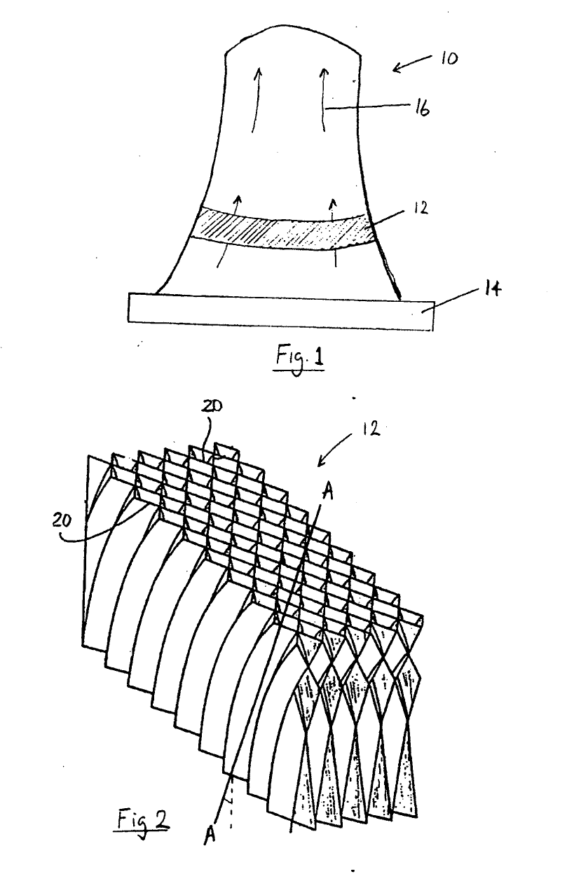

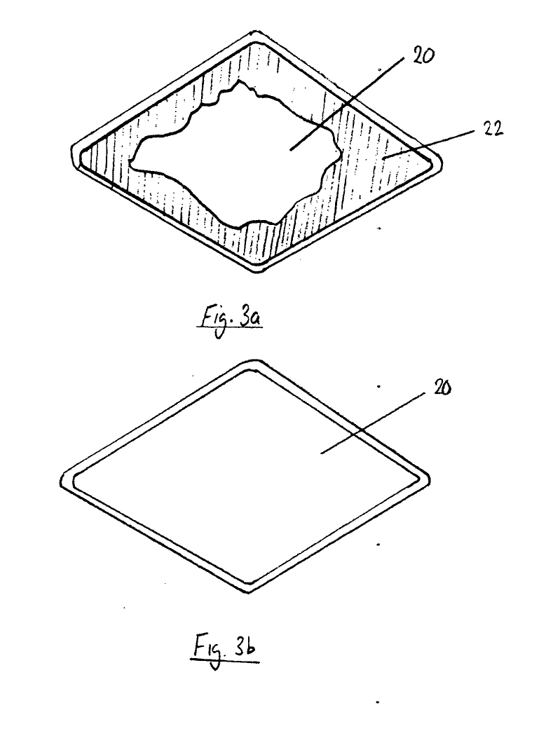

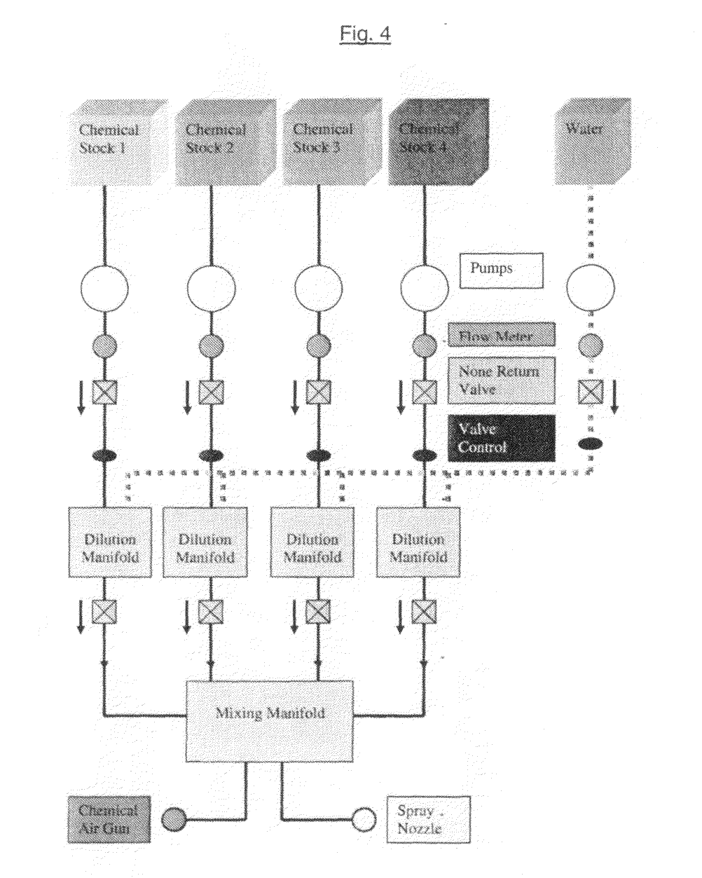

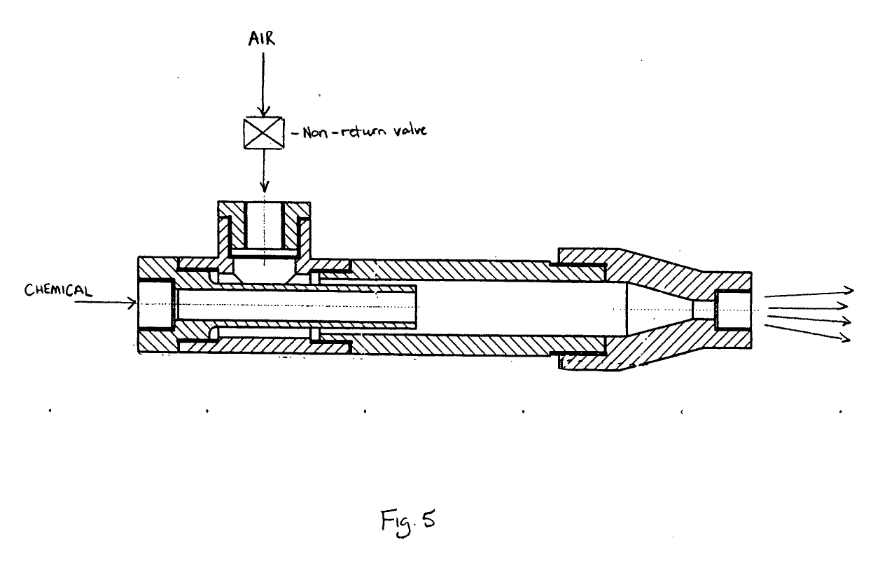

FIG. 4 is a flow diagram providing a schematic illustration of the cleaning apparatus and method of the present invention; and

FIG. 5 is cross-sectional side view of an air-assisted fluid delivery gun.

FIG. 1 shows a typical parabolic cooling tower (10) having a layer of fill material (12) towards its base. In use, a heated working medium (usually water) is introduced above the fill material (12) and travels through the fill material (12) toward an underlying sump (14) in the base of the tower (10). Airflow (16) travels in the opposite direction to the working medium to promote heat transfer within the working medium. The heat transfer occurs by means of convection and/or evaporation and is enhanced due to the fact that the working medium is sub-divided by the complex surface structure of the fill material (12) to thus present a larger surface area to the surrounding ambient airflow.

FIG. 2 shows an example of a block of fill material (12) formed from a plurality of corrugated sheets of preferably plastics material arranged side by side so as to form an array of fluted passages (20) extending between the upper and lower surfaces of the block. The general longitudinal axes of each fluted passage extend obliquely relative to an axis normal to the upper and lower surfaces of the block (12) as shown by line A-A. Whilst the fluted passages (20) illustrated in FIG. 2 extend through the depth of the block of fill material (12) in an arcuate fashion, it will be appreciated that linear fluted passages are also possible.

FIGS. 3a and 3b show schematic sectional views viewed along axis A-A shown in FIG. 2. In practice, an endoscope can be introduced into the fluted passages (20) to initially survey the quantity and type of surface deposits and/or bacteriological growths (collectively known as fouling) on the inner walls of the passages (20). FIG. 3a shows an example of a typical build up of fouling (22) within the passages (20). By comparing the respective views in FIGS. 3a and 3b (i.e. the passages with and without any fouling) it is clear that the total internal surface area within fouled passages (22) is significantly reduced.

FIG. 4 is a flow diagram from which the apparatus and its method of operation can be understood. Whilst the diagram shows four chemical cleaning fluid sources and a water source, it will be appreciated that any number of chemical sources is possible and that the water source is entirely optional. Indeed, if no dilution of the chemical cleaning fluids is required, the dilution manifolds become redundant and may be omitted. Alternatively, even if no dilution of the chemical cleaning fluids is required, the dilution manifolds may be retained and used to flush the conduits, pumps, manifolds and so forth one the chemical application is complete.

Before describing the apparatus and its method of operation in detail, it should be stated that an initial survey of the fluted passages (20) within the fill material (12) and all other component parts of the cooling structure is carried out to determine deposit type and quantity. Subsequent to that, trials are performed on various sections of the fill material (12) and other deposit samples taken from other component parts of the cooling structure to determine which chemical cleaning agents will be most effective in the dissolving and removal of the deposits, and which strengths of those chemicals would be most appropriate. In this regard, it should be appreciated that the types and severity of fouling can vary significantly over the area and volume of the fill material (12) and the other component parts of the cooling structure.

Before cleaning takes place, the cooling structure (which may be a single tower or one or more parts of a multi-celled tower) may be isolated from its water supply. However, in the case of large multi tower/cell systems, or where it is not possible to interrupt operation, it may be possible to keep the water supply in circulation during cleaning, whilst isolating only the tower or individual cell being cleaned.

A chemical supply (shown at the top of FIG. 4) is provided on site and is made up of individual chemicals including sodium hydroxide, hydrochloric acid, formic acid and hydrogen peroxide in various strengths to suit the required application. Several different chemicals may be required since the fouling in the fill material (12) and other component parts of the cooling structure is typically non-uniform in type and quantity thus the chemistry required to remove or dissolve the fouling will vary from area to area. In particular, some areas of the fill material (12) may require more or less of one particular chemical or a combination of two or more chemicals. For example, calcium scale fouling overlaid with organic deposits of mud and silt would require a combined treatment of acid and hydrogen peroxide in concentrations that suit the quantity and hardness of the fouling. A final exothermic reaction is desirable, but only at the point of application since higher temperatures make for more effective cleaning.

When chemicals of the aforementioned type are mixed together there is a very real risk of creating a runaway exothermic reaction which needs to be controlled. The apparatus of the present invention is designed specifically with this important safety issue in mind.

The apparatus of the present invention comprises a pumping rig having between two and six pumps each adapted to draw off required amounts of a chemical from its container and pump it onwards to a dilution manifold corresponding to the container. Each pump is 100% controllable using valves to set flow rates and pressures and is fitted with highly accurate flow meters. Any suitable pump type can be employed (i.e. diaphragm, impeller, centrifugal, piston, etc) and is driven by any suitable power source, (i.e. electric, pneumatic, hydraulic etc.). In order that the fill material within particularly large cooling structures can be effectively cleaned, the pumps must be capable of delivering the liquid chemical cleaning agent over distances of 200 to 300 m and at elevated heights of at least 40 m. This is important where delivery of the cleaning agents occur remote from the fill material, as is often the case. The pumps must be capable of effectively delivering the required volume of cleaning fluid to the fluid discharge nozzle/lance (for lower volume/distance applications) or air-assisted gun (for higher volume/distance applications). An example of an air assisted gun is shown in FIG. 5.

The controlling of chemical strengths and volumes is important. For example, if an acid is provided at a standard stock supply concentration of, say, 36% it may be desirable to reduce that concentration to 20% to more effectively clean the particular deposits found on an area or volume of the fill material (12) being cleaned. This is achieved by using one pump for the acid and one pump for water and setting the pumps such that they both separately deliver (by means of chemically resistant flexible hoses) predetermined volumes of acid and water to a first dilution manifold wherein the concentration of the acid is diluted to the desired level whilst being isolated from any other chemicals. Flow meters are employed to accurately measure the volumes of fluid and a valve control means can actively make any required adjustments such that the correct volumes are delivered. The diluted acid then flows into a single mixing manifold where it is optionally mixed with further chemicals which may or may not have been diluted in a similar fashion. When more than one chemical is to be used (whether diluted or not), the chemical from each separate dilution manifold flows into a single common mixing manifold. It is also important to be able to control the strength of the final mix of chemicals whilst avoiding creating too much heat which could result in melting of the plastics materials in the fill or drift eliminators. Whilst heat at the point of application is desirable, care must be taken to mix chemicals at the correct concentrations and relative volumes to prevent the generation of excessive heat. If sensitive metals are present within the cooling structure, it may also be necessary to add a corrosion inhibitor to the cleaning solution.

An important feature of the present invention is that non-return valves are fitted between the chemical and water containers/supplies and their respective dilution manifolds to prevent any possibility of back flow of chemicals which would result in undesired and potentially dangerous combinations of chemicals prior to their entry into the mixing manifold. The dilution manifolds are therefore isolated from the various fluid sources (and from the common mixing manifold) by the non-return valves. In particular, this design is intended to prevent dangerous exothermic reactions occurring within the pumping rig or the chemical supply containers.

Similarly, non-return valves are fitted between the dilution and mixing manifolds to prevent any possibility of back flow of mixed and/or diluted chemical cleaning agents from the mixing manifold towards any of the dilution manifolds.

After mixing occurs within the mixing manifold the chemical cleaning agent travels onwards to an air assisted ‘gun’ or a spray lance (i.e. a lightweight extendable pole) having a discharge nozzle. Within the gun the chemical cleaning agent passes through a venturi tube (see FIG. 5) where air is added at between 20-100 cf/m (0.57-2.83 m³ per minute) and is regulated from source to suit the required flow rate for the fouling type encountered. This creates a chemical deluge that can propel cleaning fluid in excess of 20 m from the gun but can also be regulated by reducing the air and/or chemical flow to much lower rates to suit the particular requirements. This allows the operator to spray chemical agents onto an extended area of the fill material and other component parts of the cooling structure quickly without having to move unnecessarily. An operator can regulate distance, flow rates and type and strength of chemical to suit the previously identified fouling types (i.e. mapped during the initial survey) by radioing a person controlling the pumps and air supply. Alternatively, air control means having a non-return valve may be provided locally, or on the gun itself, such that the operator can control all aspects of the operation. Application of the chemical cleaning agent can be accurately controlled by employing interchangeable discharge nozzles on the gun or lance thus offering a variety of differing directional spray patterns and discharge volumes.

Importantly, once the chemical cleaning agent passes through the mixing manifold there are no valves or any other means of isolating, containing or inhibiting the flow through the spray lance or air gun. This arrangement ensures that in the event of an exothermic reaction occurring within or after the mixing manifold, the expanding chemical agents are safely expelled through the spray lance or air gun. Accordingly, whilst the apparatus of the present invention is arranged to prevent exothermic reactions occurring within closed/contained parts of the apparatus, even if they do occur after the mixing manifold, they are safely expelled from the delivery means thus avoiding any dangerous build up of pressure within the apparatus.

In order to further control risk, the mixing manifold is placed as close to the air gun or discharge nozzle as possible to minimise the amount of mixed chemicals in the flexible delivery hose and thus further reducing the possibility of chemical mixtures becoming dangerously exothermic within the apparatus and not being able to expand and evacuate from the apparatus. Indeed, the mixing manifold may be located within the fluid delivery assembly in the form of a multi-headed mixer.

A further advantage of the present invention is that because strong chemical solutions of, say, acid and hydrogen peroxide are mixed immediately prior to their delivery onto fouled fill material, the resultant heat causes violent reactions to occur in contact with the fouling instead of occurring within the delivery apparatus (i.e. in the hoses and mixing manifold). Accordingly, the key to effective cleaning involves optimising the following variables in accordance with the type and severity of fouling encountered:
(i) applying appropriate volumes of chemicals;
(ii) applying appropriate concentrations of chemicals;
(iii) timing the application of the mixed chemicals to the fouling such that high intensity reactions occur on the fouling as opposed to within the delivery system;
(iv) ensuring that the mixed chemicals have a sufficiently high density to enable them to descend down through the fill material under the influence of gravity against the influence of natural up drafts (i.e. foamed mixtures are inadequate for this purpose).
(v) controlling the mixture strength in order to optimise exothermic reactions such that the heat created is sufficient to provide the desired cleaning action whilst being insufficient to overheat or damage the fill material or drift eliminators.

If required, the method and apparatus can additionally achieve simultaneous disinfection of the fill material and component parts of a cooling structure. Indeed, references throughout the specification to the cleaning of such structures should be understood to include, where appropriate, their simultaneous disinfection.

Once the chemical removal of fouling is completed (usually within 40 minutes), the fill material is rinsed out using a larger diameter fire-hose type supply. Alternatively, the cooling structure is put back into operation such that water circulation resumes and washes away spent chemicals and any dislodged fouling. The spent chemical and fouling is washed into the cooling tower sump where the chemical can, if required, be neutralised by making a pH adjustment by adding an acid or a caustic solution. Also, if required any remaining hydrogen peroxide can be degraded by adding sodium bisulphate. If the sump is empty the deposits will collect in the sump and can be readily removed. However, if the cooling structure remains in circulation during cleaning, the fouling is submerged in the sump and can be removed at the next scheduled shutdown. On larger systems such as power stations or petrochemical plants the dilutions factors achieved (i.e. the ratio of circulating cooling water to chemicals added) are so large that they generally do not reach the point of detection and if they are detected they are comparatively low and again may be adjusted by adding a neutralising agent such as sodium bisulphate if required.

Particular combinations of chemicals used act as a very effective disinfectant as confirmed by independent laboratory testing, in particular, hydrochloric acid and hydrogen peroxide. Accordingly, in addition to cleaning the fill material, the chemical cleaning agents of the present invention are effective in killing any bacteria or pathogens present including Legionellosis. At present this is a legal requirement for cooling structures in several countries.

Modifications and improvements may be made to the foregoing without departing from the scope of the present invention.

1. Apparatus for cleaning fill material in evaporative heat transfer structures, the apparatus comprising:
(i) two or more cleaning fluid input conduits;
(ii) fluid pumping means for selectively pumping fluids through each input conduit;
(iii) fluid-flow control means for selectively controlling the fluid flow through each input conduit;
(iv) a mixing manifold in fluid communication with each cleaning fluid input conduit; and
(v) an output conduit for delivering mixed cleaning fluid from the mixing manifold to a structure to be cleaned;
wherein each fluid-flow control means comprises a non-return valve provided on the cleaning fluid input conduit for precluding inadvertent mixing of cleaning fluids upstream of the mixing manifold.

2. Apparatus as claimed in claim 1, further comprising a water input conduit.

3. Apparatus as claimed in claim 2, wherein the water input conduit comprises corresponding means for selectively pumping and/or controlling the water through its input conduit.

4. Apparatus as claimed in claim 2 or 3, wherein the apparatus further comprises two or more dilution manifolds positioned upstream of the mixing manifold, each dilution manifold being in fluid communication with the mixing manifold, one of the cleaning fluid input conduits and the water input conduit respectively thus facilitating the delivery of mixed and/or diluted or undiluted cleaning fluid to a structure to be cleaned.

5. Apparatus as claimed in claim 4, wherein, a further non-return valve is provided on the cleaning fluid input conduit for precluding inadvertent mixing of cleaning fluids upstream of the dilution manifold.

6. Apparatus as claimed in claim 4 or 5, wherein a non-return valve is positioned between the mixing manifold and each dilution manifold.

7. Apparatus as claimed in any preceding claim, wherein the fluid-flow control means for controlling the fluid flow through each cleaning fluid input conduit comprises a flow meter.

8. Apparatus as claimed in any preceding claim, wherein the fluid-flow control means for controlling the fluid flow through each cleaning fluid input conduit comprises a valve control means.

9. Apparatus as claimed in any preceding claim, wherein the output conduits are free of any fluid-flow control means.

10. Apparatus as claimed in any preceding claim, wherein the input and output conduits are flexible hoses.

11. Apparatus as claimed in any preceding claim, wherein an air input conduit is connected to the output conduit for propelling cleaning fluid towards a structure to be cleaned.

12. A method for cleaning fill material in evaporative heat transfer structures, the method comprising the steps of:
(i) providing two or more sources of cleaning fluids;
(ii) selectively conveying cleaning fluid from one or more of their sources into a mixing manifold;
(iii) providing a non-return valve between each cleaning fluid source and the mixing manifold for precluding back flow and inadvertent mixing of cleaning fluids upstream of the mixing manifold; and
(iv) providing a delivery means to deliver the mixed cleaning fluid from the mixing manifold to a structure to be cleaned.

13. A method as claimed in claim 12, wherein the method comprises the additional steps of:
(i) providing a source of water;
(ii) providing one or more dilution manifolds positioned upstream of the mixing manifold which is common to each dilution manifold;
(iii) selectively conveying cleaning fluid from one or more of their sources into a corresponding one or more dilution manifold(s);
(iv) optionally, conveying water contemporaneously from its source into one or more of the same dilution manifold(s) to facilitate dilution of the cleaning fluid therein to a desired concentration;
(v) conveying the undiluted or diluted cleaning fluid from the or each dilution manifold to the common mixing manifold to facilitate the subsequent delivery of mixed and/or diluted or undiluted cleaning fluid to a structure to be cleaned.

14. A method as claimed in claim 13, wherein the steps of conveying cleaning fluid and, optionally, water from their respective sources is achieved by providing pumping means to pump them into the dilution manifold(s).

15. A method as claimed in claim 13 or 14, wherein the steps of conveying cleaning fluid and, optionally, water from their respective sources involves controlling the relative volumes being introduced into the dilution manifold(s).

16. A method as claimed in any one of claims 13 to 15, wherein the step of conveying the undiluted or diluted cleaning fluid from the or each dilution manifold to the common mixing manifold is achieved whilst preventing any back flow of the respective fluids to the dilution manifold(s).

17. A method as claimed in any one of claims 12 to 16, wherein the step of providing a delivery means to deliver the mixed and/or undiluted or diluted cleaning fluid from the mixing manifold to a structure to be cleaned involves supplying air to the delivery means to for propelling cleaning fluid towards the structure to be cleaned.

18. A method as claimed in any one of claims 12 to 17, wherein the method includes the further step of rinsing the structure to be cleaned with water to remove spent cleaning fluid and/or dislodged fouling once the step of delivering the mixed and/or undiluted or diluted cleaning fluid is completed.

19. A method as claimed in any of claims 12 to 18, wherein the step of providing sources of cleaning fluids comprises providing chemicals selected from the group comprising: sodium hydroxide, hydrochloric acid, formic acid and hydrogen peroxide.
